(19) United States
(12) Patent Application Publication
(10) Pub. No.: US 2013/0112641 A1
(43) Pub. Date: May 9, 2013

(54) GRAVITY POWERED BALANCING SYSTEM

(71) Applicants: GM GLOBAL TECHNOLOGY OPERATIONS LLC, Detroit, MI (US); Universite Laval, Quebec (CA)

(72) Inventors: Thierry Laliberte, Quebec (CA); Clement Gosselin, Quebec (CA); Dalong Gao, Rochester, MI (US); Roland J. Menassa, Macomb, MI (US)

(73) Assignees: Universite Laval, Quebec (CA); GM GLOBAL TECHNOLOGIY OPERATIONS LLC, Detroit, MI (US)

(21) Appl. No.: 13/664,952

(22) Filed: Oct. 31, 2012

Related U.S. Application Data
(60) Provisional application No. 61/555,817, filed on Nov. 4, 2011.

(51) Int. Cl. B25J 19/00; B66C 13/00

(52) U.S. Cl. CPC B25J 19/002; B66C 13/00
USPC 212/196; 16/400

(57) ABSTRACT

A balance assist system includes a support structure, an assist device, a variable balancing system, and a balancing cable. The variable balancing system is configured for moving a mass in a vertical direction along a Z axis. The variable balancing system includes a balance platform, a lever, and a mobile counterweight. The lever is pivotally attached to the balance platform at a fixed pivot point such that the lever is pivotable at the fixed pivot point about a balance axis. The mobile counterweight is movably disposed on the lever relative to the fixed balance axis and movable between a minimum position and a maximum position. The minimum position corresponds to the mass having a minimum weight such that the mass is statically balanced along the Z axis. Likewise, the maximum position corresponds to the mass having a maximum weight such that the mass is statically balanced along the Z axis.

### CROSS-REFERENCE TO RELATED APPLICATIONS

This application claims the benefit of U.S. Provisional Patent Application No. 61/555,817 filed on Nov. 4, 2011, which is hereby incorporated by reference in its entirety.

### TECHNICAL FIELD

The present invention relates to a balance assist system that is configured for moving a payload in a vertical direction.

### BACKGROUND

Overhead bridge cranes are widely used to lift and relocate large payloads. Generally, the displacement in a pick and place operation involves three translational degrees of freedom and a rotational degree of freedom along a vertical axis. This set of motions, referred to as a Selective Compliance Assembly Robot Arm (“SCARA”) motions or “Schönflies” motions, is widely used in industry. A bridge crane allows motions along two horizontal axes. With appropriate joints, it is possible to add a vertical axis of translation and a vertical axis of rotation. A first motion along a horizontal axis is obtained by moving a bridge on fixed rails while the motion along the second horizontal axis is obtained by moving a trolley along the bridge, perpendicularly to the direction of the fixed rails. The translation along the vertical axis is obtained using a vertical sliding joint or by the use of a belt. The rotation along the vertical axis is obtained using a rotational pivot with a vertical axis.

There are partially motorized versions of overhead bridge cranes that are displaced manually along horizontal axes and rotated manually along the vertical axis by a human operator, but that includes a motorized hoist in order to cope with gravity along the vertical direction. Also, some bridge cranes are displaced manually along all of the axes, but the weight of the payload is compensated for by a balancing device in order to ease the task of the operator. Such bridge cranes are sometimes referred to as assist devices. Balancing is often achieved by pressurized air systems. These systems need compressed air in order to maintain pressure or vacuum—depending on the principle used—which requires significant power. Also, because of the friction in the compressed air cylinders, the displacement is not very smooth and can even be bouncy. Balancing can be achieved using counterweights, which add significant inertia to the system. Although helpful and even necessary for the vertical motion, such systems attached to the trolley of a bridge crane add significant inertia regarding horizontal motion due to moving the mass of these systems. In the case of balancing systems based on counterweights, the mass added can be very large, even larger than the payload itself. If the horizontal traveling speed is significant, the inertia added to the system becomes a major drawback.

There are also fully motorized versions of such bridge cranes that require powerful actuators, especially for the vertical axis of motion which has to support the weight of the payload. These actuators are generally attached to the trolley or bridge and are then in motion. The vertical translation actuator is sometimes attached to the bridge and linked to the trolley by a system similar to what is used in tower cranes.

### SUMMARY

A balance assist system includes a support structure, an assist device, a variable balancing system, and a balancing cable. The assist device is movably supported by the support structure. The assist device is configured for movement relative to the support structure along at least one of an X axis and a Y axis. The mass is vertically supported by the assist device. The variable balancing system is configured for moving the mass in a vertical direction along a Z axis. The variable balancing system includes a balance platform, a lever, and a mobile counterweight. The lever is pivotally attached to the balance platform at a fixed pivot point such that the lever is pivotable at the fixed pivot point about a balance axis. The mobile counterweight is movably disposed on the lever relative to the fixed balance axis and movable between a minimum position and a maximum position. The balancing cable operatively connects the support structure, the lever, and the mass such that the mass is vertically supported by the support structure via the balancing cable. The minimum position corresponds to the mass having a minimum weight such that the mass is statically balanced along the Z axis. Likewise, the maximum position corresponds to the mass having a maximum weight such that the mass is statically balanced along the Z axis.

A variable balancing system is configured for moving a mass in a vertical direction along a Z axis. The variable balancing system includes a balance platform, a lever, and a mobile counterweight. The lever is pivotally attached to the balance platform at a fixed pivot point such that the lever is pivotable at the fixed pivot point about a balance axis. The mobile counterweight is movably disposed on the lever relative to the fixed balance axis and movable between a minimum position and a maximum position. The minimum position corresponds to the mass having a minimum weight such that the mass is statically balanced along the Z axis. Likewise, the maximum position corresponds to the mass having a maximum weight such that the mass is statically balanced along the Z axis.

A method of balancing a variable balancing system includes vertically supporting a mass along the Z axis by a lever which is pivotally supported at a pivot point. A counterweight is moved along the lever to change a center of gravity of the lever. Movement of the counterweight along the lever is stopped once the center of gravity of the lever is coincident with the mass such that the mass is statically balanced along the Z axis.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic perspective view of a balance assist system including a variable balancing system operatively connected to a support structure;

FIG. 2 is a schematic perspective view of the variable balancing system of FIG. 1;

FIGS. 3A-3J are schematic diagrammatic views of a sequence of ten operations of a passive balancing device of the variable balancing system with a brake at a fixed pivot point;

FIGS. 4A-4J are schematic diagrammatic views of a sequence of ten operations of a passive balancing device of the variable balancing system without a brake at a fixed pivot point;

FIGS. 5A-5C are schematic diagrammatic views of a sequence of three operations of a mechanical scale system for gravity-powered self-tuning balancing;

FIG. 6A-6D are schematic diagrammatic views of a sequence of four operations of a mechanical scale system for gravity-powered self-tuning balancing using a lifting action;

FIG. 7 is a schematic diagrammatic view of parameters of the mechanical scale system of FIGS. 5 and 6;

FIGS. 8A and 8B are schematic diagrammatic views of the balancing system of FIG. 1 attached to the payload through cable routing; and

FIGS. 9A and 9B are schematic diagrammatic views of a sequence of two operations of a balancing device of the variable balancing system using a small counterweight in addition to a counterweight.

### DESCRIPTION OF THE PREFERRED EMBODIMENTS

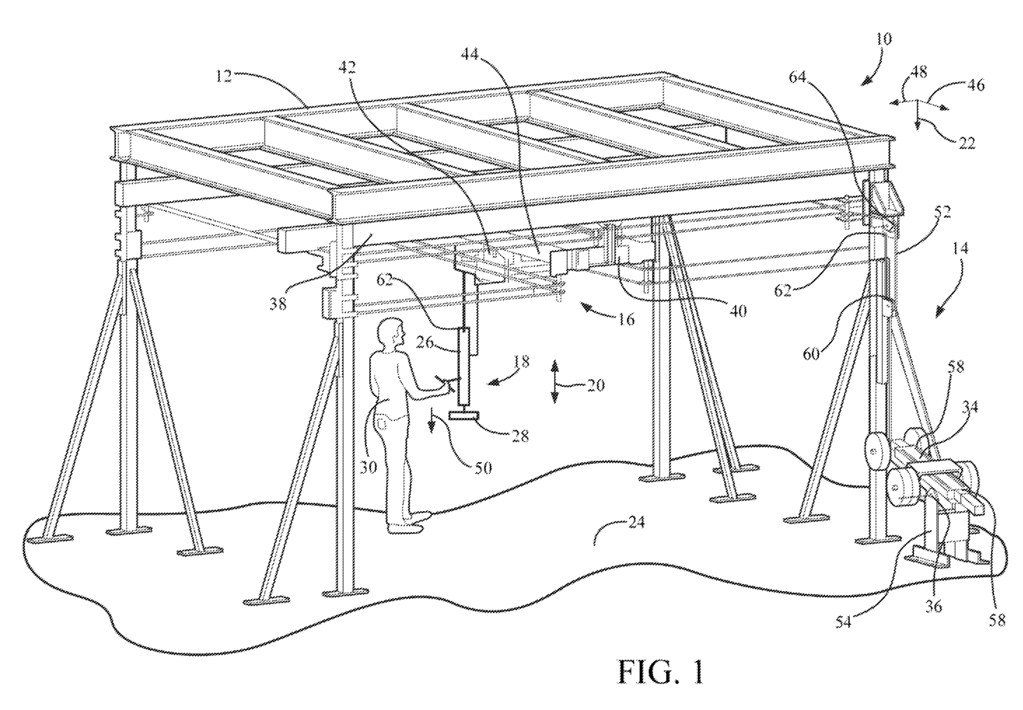

Referring to the drawings, wherein like reference numbers refer to like components, a balance assist system is shown at 10 in FIG. 1. The balance assist system 10 includes a stationary support structure 12, a variable balancing system 14, an assist device 16, and a mass 18. The variable balancing system 14 is configured for moving the mass 18 in a vertical direction 20 along a Z axis 22, relative to the ground 24, as shown at in FIG. 1. The mass 18 may include an end effector 26, where the end effector 26 is supported by the assist device 16. The end effector 26 may selectively support a payload 28.

When heavy payloads 28 are moved manually by an operator 30, it is of interest to compensate for the weight. This may be done using the balance assist system 10 which is based on counterweights. If masses are mounted on a lever 34 that can rotate around a fixed pivot point 36, the global system is statically balanced if the center of mass of the moving masses is coincident with the fixed pivot point 36. This principle can also be implemented through other mechanical transmissions, such as cables, pneumatic components or a combination of them. In practice, one of the moving masses is generally a payload 28 while the others are counterweights chosen to balance the payload 28. When a mechanical system is balanced, the payload 28 can be moved vertically up and down with very little effort because the gravitational forces are always compensated for. In applications where the payload 28 can vary, counterweights can be displaced along the lever 34 (or other mechanical systems) in order to adjust to the variable payload 28. It is of interest to use gravity-powered mechanical systems to balance the payload 28 in the vertical direction 20, i.e., mechanical systems that do not require the use of external power.

The support structure 12 includes, but is not limited to, a pair of parallel rails 38 or runway tracks. Generally, the assist device 16 is supported by the parallel rails 38 of the support structure 12. The assist device 16 may include a bridge crane 40 and a trolley 42. The bridge crane 40 is a structure that includes at least one girder 44 that spans the pair of parallel rails 38. The bridge crane 40 is adapted to carry the payload 28 horizontally, relative to the ground 24, along a Y axis 48. The trolley 42 is movably attached to the girders 44 of the bridge crane 40 such that the trolley 42 is adapted to carry the payload 28 horizontally, relative to the ground 24, along an X axis 46. The Z axis 22 extends in a generally vertical direction 20, relative to the ground 24. Additionally, the end effector 26 movably extends from the trolley 42 such that the end effector 26 is adapted to carry or support the payload 28 in the generally vertical direction 20 along the Z axis 22.

Referring to FIG. 1, movement along the Z axis 22 is decoupled from horizontal movement of the assist device 16 along the X and Y axes 46, 48. This means that the vertical movement of the assist device 16 is decoupled from the horizontal movements of the end effector 26 and any associated payload 28, along the X and Y axes 46, 48.

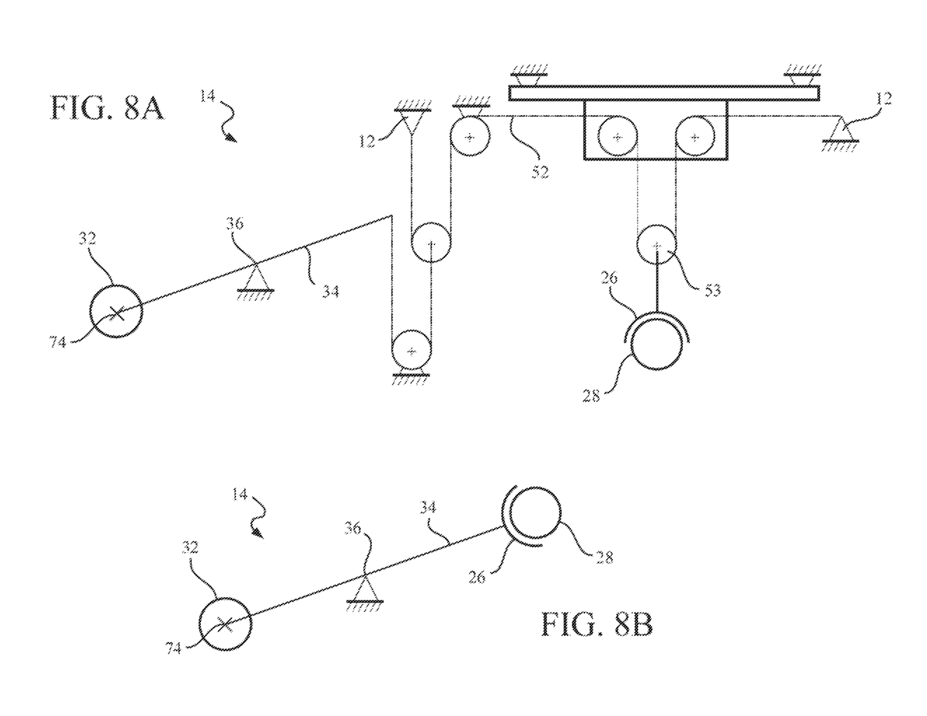

The variable balancing system 14 may be disposed on the ground 24. The variable balancing system 14 is configured to provide a counterbalance to the mass 18, i.e., the end effector 26, and any associated payload 28, such that the end effector 26, and any associated payload 28, is statically balanced along the Z axis 22. Statically balanced means that the mass 18 may selectively move along the Z axis 22 in response to the application of a vertical force 50 to the mass 18. However, when the application of the vertical force 50 is stopped, the end effector 26, and any associated payload 28, generally remains in the same vertical position along the Z axis 22 as they are “statically balanced”. At least one balancing cable 52 operatively interconnects the end effector 26, the variable balancing system 14, and the support structure 12. More specifically, at one end, the balancing cable 52 is operatively connected to the support structure 12. The balancing cable 52 may be a cable, a belt, a chain, or any other object or device configured to interconnect the support structure 12, the variable balancing system 14, and the end effector 26. Additionally, with reference to FIGS. 8A and 8B, both ends of the balancing cable 52 are attached to the structure 12 and a pulley 53 is operatively disposed between the balancing cable 52 and the end effector 26.

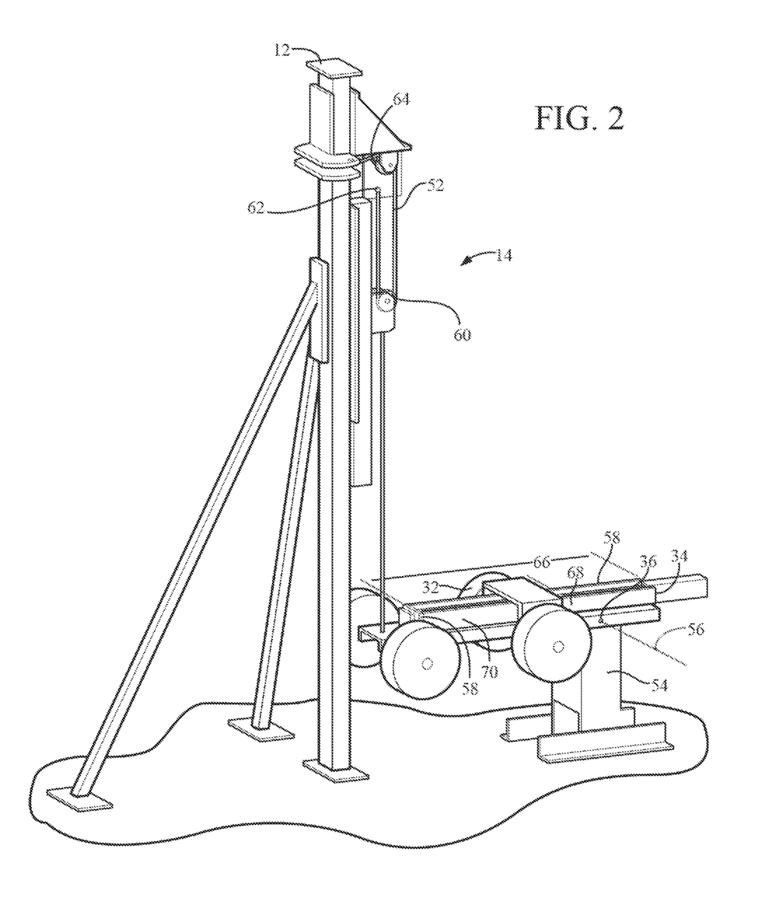

As shown in FIGS. 1 and 2, the variable balancing system 14 includes a balance platform 54 and the lever 34 that is pivotally attached to the balance platform 54 at the fixed pivot point 36 such that the lever 34 pivots about a balance axis 56 at the fixed pivot point 36. The static balancing of the payload 28 is performed using a mobile counterweight 32 that is located along the lever 34 to make the center of mass of the moving system, i.e., the end effector 26 and payload 28, coincident with the fixed pivot point 36. The lever 34 has opposing ends 58. The balancing cable 52 is operatively attached to the support structure 12 proximate one of the ends 58. A first pulley 64 may be disposed remote from the variable balancing system 14, e.g., disposed on the support structure 12. A second pulley 60 may be disposed between the first pulley 64 and one of the ends 58 of the lever 34. The lever 58 is operatively attached to the second pulley 60, proximate one of the ends 58, as illustrated in FIG. 2. The balancing cable 52 may be fixed to the support structure 12 at an attachment point 62 where the balancing cable 52 then extends around the second pulley 60, which is operatively attached to the lever 58. Then, the balancing cable 52 extends from the second pulley 60 and extends around the first pulley 64, which is operatively attached to the support structure 12.

At least one mobile counterweight 32 is operatively attached to the lever 34. The mobile counterweight 32 is configured to move a distance 66 along the lever 34 between a minimum position 68 and a maximum position 70 to counter the weight associated with the mass 18 and statically balance the mass 18. When the mobile counterweight 32 is at the minimum position 68, the mobile counterweight 32 is moved along the lever 34 such that the mobile counterweight 32 is closer to the balance axis 56 than when the mobile counterweight 32 is at the maximum position 70. The position of the mobile counterweight 32 at the minimum position 68, the maximum position 70, or at any other position between the minimum and maximum positions 68, 70, are configured to statically balance the end effector 26, and any associated payload 28, along the Z axis 22. Therefore, when the mobile counterweight 32 is at the minimum position 68, the end effector 26 may not be supporting a payload 28, or may be supporting a minimum payload 28, i.e., the payload 28 having a minimum weight for the design of the variable balancing system 14, while remaining statically balanced along the Z axis 22. Likewise, when the mobile counterweight 32 is at the maximum position 70, the end effector 26 is supporting a maximum payload 28, i.e., the payload 28 having a maximum weight for the design of the variable balancing system 14, while remaining statically balanced along the Z axis 22. However, the mobile counterweight 32 may also be positioned anywhere along the lever 34 between the minimum position 68 and the maximum position 70 that is configured to vertically balance the end effector 26 that is supporting a payload 28 that weighs less than the maximum payload 28, but more than the minimum payload 28. When the mobile counterweight 32 is in a balanced position along the lever 34, the mass 18 may be moved vertically along the Z axis 22 with very little effort exerted by the operator 30.

In response to the movement along the Z axis 22 the lever 34 may pivot relative about the balance axis 56, while the counterweight 32 provides assistance to the vertical movement, while keeping the mass 18 statically balanced in the vertical direction. With reference to FIGS. 1 and 2, as the lever 34 pivots about the balance axis 56, the second pulley 60 moves in the vertical direction, such that the second pulley 60 moves along the balancing cable 52, relative to the corresponding attachment point 62. Likewise, as the second pulley 60 moves along the balancing cable 62, the balance cable 62 also moves relative to the first pulley 60.

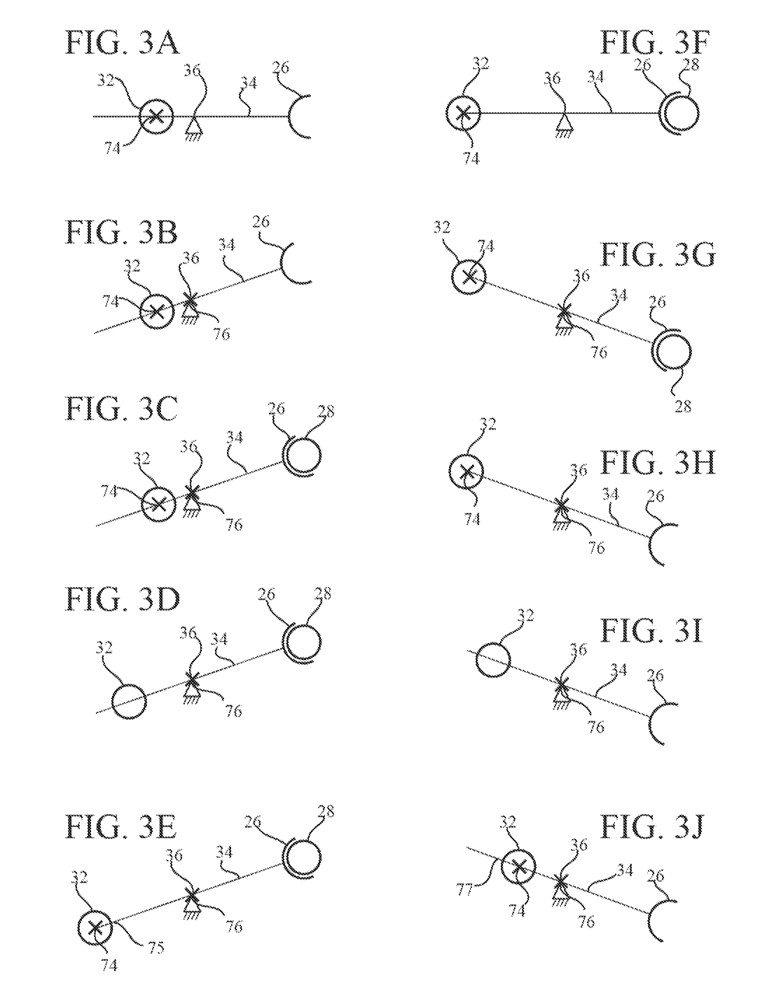

During operation, the payload 28 needs to be grabbed and released and therefore at least two states of balancing are needed. Perfect balancing can be obtained in both states by moving the mobile counterweight 32 along the lever 34. In order to avoid the use of powerful actuators, gravity is used to displace the mobile counterweight 32 along the lever 34. Referring specifically to FIGS. 3A-3J, brakes 74 are used in order to establish a sequence of balanced states. This sequence will be presented in details below. The proposed passive balancing is possible under certain conditions. Mainly, the payload 28 must be picked up at a location that is higher than the release location, in the Z direction, which allows the use of the gravitational potential energy of the payload 28 to energize the variable balancing system 14.

The balancing system may be tuned to the weight of the payload 28. This is possible by weighing the payload 28 with the use of a mechanical scale that includes a spring 96. Using a mechanical scale, the mobile counterweight 32 is moved along the lever 34 by a distance proportional to the weight of the payload 28 in order to obtain a balanced system. As in the previous embodiment, brakes 74 are used in order to obtain the sequence of states that allows balancing. The conditions that allow proper balancing are described in what follows and the mathematical relations that must be satisfied are given.

Referring to FIGS. 3A-3J, a sequence of operations of a passive balancing device with a brake 74 at the fixed pivot point 36 are shown. For reference, the cross “X” denotes a locked joint 76. Under certain conditions, it is possible to adjust the balancing of an assist device 16 between unloaded and loaded states without significant external power. More specifically, the mobile counterweight 32 is moved along the lever 34, between the two positions, using gravity to power the motion. The following sequence explains the principle of operation. The corresponding steps in FIG. 3A-3J are represented in sequence starting from FIG. 3A and moving in sequential order to FIG. 3J. Referring specifically to FIG. 3A, in the unloaded state, the position of the mobile counterweight 32 is locked close to the pivot and the lever 34 is free to move or otherwise pivot. Referring to FIG. 3B, the end effector 26 is placed close to the payload 28, which is located high enough so that the mobile counterweight 32 side of the lever 34 is pointing down toward the ground 24. Then, the lever 34 is locked at the fixed pivot point 36. With the lever 34 locked at the fixed pivot point 36, FIG. 3C shows that the payload 28 is grasped. FIG. 3D shows that in order to balance the loaded end effector 26, the mobile counterweight 32 is unlocked and falls along the lever 34 (gravity assisted) until an adjusted position that balances a loaded end effector 26 is reached (via a mechanical stop 75). Referring to FIG. 3E, the mobile counterweight 32 is locked to the lever 34. Referring to FIG. 3F, the lever 34 is unlocked at the fixed pivot point 36, allowing displacement of the loaded end effector 26 in the Z direction, while statically balanced. Referring to FIG. 3G, the payload 28 is placed at its new location, which is located low enough in the Z direction so that the mobile counterweight 32 side of the lever 34 is pointing up, relative to the ground 24, and the lever 34 is locked at the fixed pivot point 36. Referring to FIG. 3H, the payload 28 is released from the end effector 26. Referring now to FIG. 3I, in order to balance the unloaded end effector 26, the mobile counterweight 32 is unlocked and falls along the lever 34 (gravity assisted) until an adjusted position that balances the unloaded end effector 26 is reached (via a mechanical stop 77). FIG. 3J shows that the mobile counterweight 32 is locked on the lever 34. When the fixed pivot point 36 of the configuration of FIG. 3J is unlocked, the balancing device returns to the configuration shown in FIG. 3A.

It should be appreciated that the system described above can work only when the weight of the payload 28 and end effector 26 are known in advance. This condition is necessary in order to properly set the positions of the mechanical stops 75, 77 associated with the balancing states. Knowing the mass of new payloads 28, the mechanical stops 75, 77 could be adjusted on-the-fly accordingly. Additionally, the vertical height at which the payload 28 is grabbed must be higher than a reference height and the height at which the payload 28 is released must be lower than the reference height, (the lever 34 is horizontal in the reference height,) allowing the mobile counterweight 32 to move in the appropriate direction for balancing. Also, under this condition, the energy needed to displace the mobile counterweight 32 is supplied by the gravitational potential energy lost by the payload 28 between its grasp and release states. Additionally, two locking systems 78 must be included: one for the fixed pivot point 36 and one for the mobile counterweight 32. These two systems allow an operator 30 to control the balancing state of the assist device 16. These systems should not need significant power. The deceleration of the mobile counterweight 32 can be minimized by energy absorbers at the ends of the stroke. Moreover, the acceleration of the mobile counterweights 32 at the beginning of their motion along the lever 34 could be increased by springs that would deliver energy stored during the previous deceleration. If different payloads 28 with different known weights are to be handled, the balancing settings could be modified by the operator 30 or system prior to the grasp.

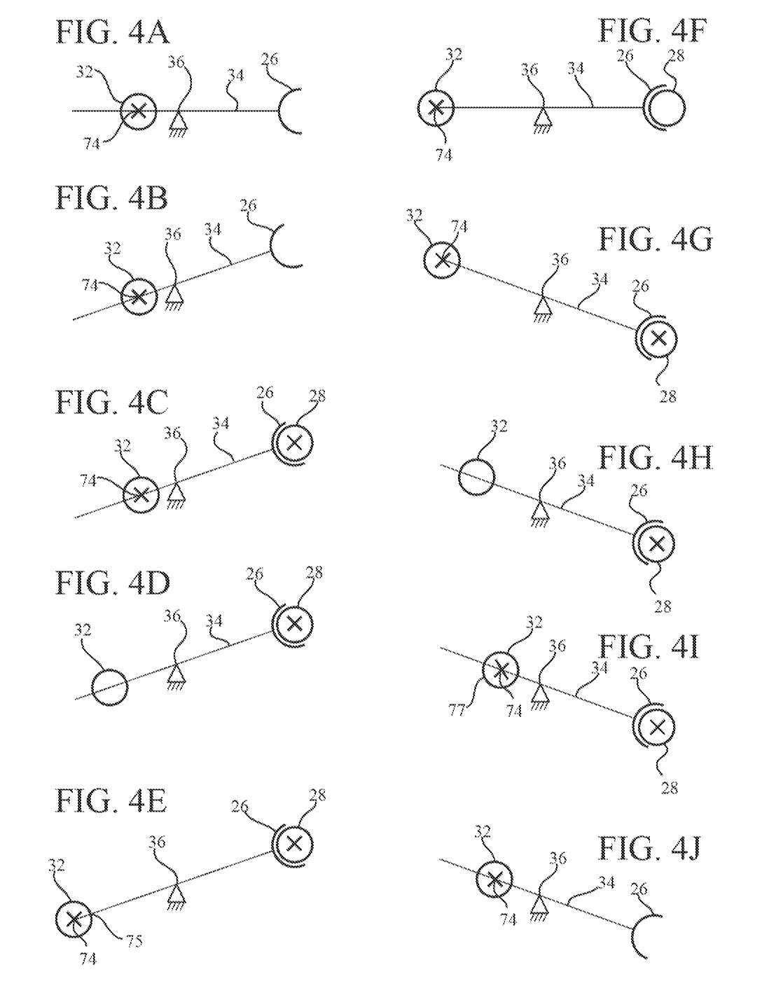

In the sequence described above, it is assumed that the payload 28 is placed on the end effector 26 at the pick-up location and dropped from the assist device 16 at the released location. However, in most cases, the payload 28 is in fact picked up from a support and released on a fixture or other fixed surface. Under these conditions, the support from which the payload 28 is picked up or released can be used for stabilization and the brake 74 at the fixed pivot point 36 is no longer necessary, as illustrated in FIGS. 4A-4J. The following sequence explains the principle of operation of the balancing device without the brake 74 at the fixed pivot point 36. The corresponding steps in FIGS. 4A-4J are represented in sequence starting at FIG. 4A and moving in sequential order to FIG. 4J. Referring specifically to FIG. 4A, in the unloaded state, the position of the mobile counterweight 32 is locked close to the fixed pivot point 36 and the lever 34 is free to move or pivot about the fixed pivot point 36. Referring now to FIG. 4B, the end effector 26 is placed close to the payload 28, which is located vertically high enough so that the mobile counterweight 32 side of the lever 34 is pointing down, with respect to the ground 24. Referring now to FIG. 4C, the payload 28 is grasped. Since the payload 28 is resting on a support, any motion of the lever 34 is prevented. Referring to FIG. 4D, in order to balance the loaded assist device 16, the mobile counterweight 32 is unlocked and falls along the lever 34 (gravity assisted) until an adjusted position that balances a loaded end effector 26 is reached. Referring to FIG. 4E, the mobile counterweight 32 is locked. Referring to FIG. 4F, it is then possible to displace the loaded end effector 26 while statically balanced. FIG. 4G shows that the payload 28 is placed at its new location, which is located vertically low enough in the Z direction so that the mobile counterweight 32 side of the lever 34 is pointing up, relative to the ground 24. Since the payload 28 is resting on a support, any motion of the lever 34 is prevented. FIG. 4H illustrates that in order to balance the unloaded end effector 26, the mobile counterweight 32 is unlocked and falls along the lever 34 (gravity assisted) until an adjusted position that balances an unloaded end effector 26 is reached. Referring to FIG. 4I, the mobile counterweight 32 is locked to the lever 34. FIG. 4J shows that the payload 28 is released from the end effector 26, which brings the end effector 26 to its initial state (FIG. 4A).

If an automatic sequencing is used, the operator 30 only has to move the assist device 16, operate the end effector 26 to grasp the payload 28, and operate the end effector 26 to release the payload 28. When the payload 28 is grasped, the mobile counterweight 32 is then released and falls along the lever 34 to the new position. In order to prevent the end effector 26 from picking up a payload 28 or releasing a payload 28 while the mobile counterweight 32 is moving along the lever 34, the grasping and/or releasing by the end effector 26 may be deactivated while the mobile counterweight 32 is in motion along the lever 34. By way of a non-limiting example, a limit switch may be operatively attached to the lever 34 to sense the position of the mobile counterweight 32.

In order to increase the range of motion in which the payload 28 can be released, assuming that the grabbing range of motion can be smaller, the reference height can be displaced. This can be performed with a constant force applied on the mobile counterweight 32 along its axis of motion. One way to apply this force is to attach a mass to the main mobile counterweight 32 through the balancing cable 52 and to suspend the mass through a pulley in order to continuously locate the mass under the pivot point. This allows an equilibrium configuration of the mobile counterweight 32 to be obtained which is different from the one in which the lever 34 is horizontal.

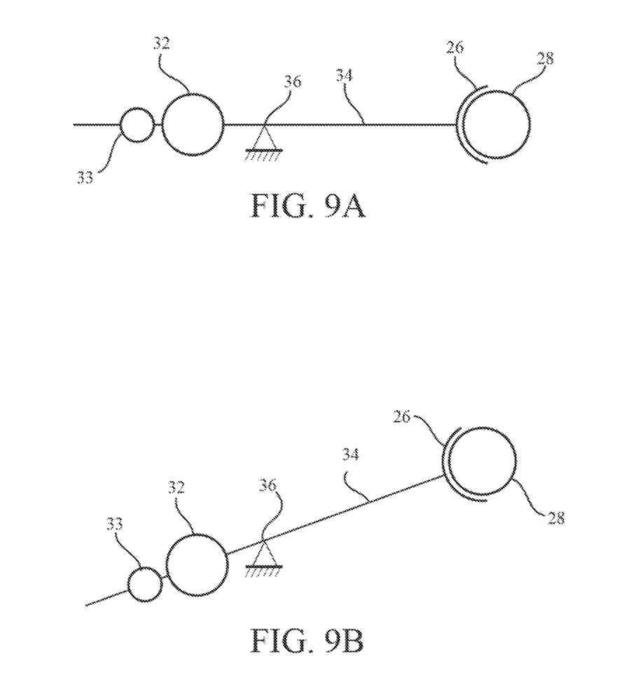

With reference to FIGS. 9A and 9B, if the predefined stop 75 is removed, the mobile counterweight 32 will keep sliding down the lever 34. In this scenario, if the payload 28 is simply supported and the mobile counterweight 32 slides down a little further than the balanced position on the lever 34, the lever 34 will be in a slight overbalance (more torque from the mobile counterweight 32 to the pivot than the torque from the payload 28) and the mobile counterweight 32 will lift the payload 28. This overbalance can be used to detect that the mobile counterweight 32 is appropriately located for balancing and adapt to different payloads 28. Instead of having a predefined stop position for the mobile counterweight 32 for each payload 28, the mobile counterweight 32 is stopped at the position that allows a slight vertical lift of the payload 28, which is near the balanced configuration. The slight imbalance can be removed to return to the perfect balance. This can be done by the displacement of a small counterweight 33 or by the application of a small lifting force on the lever 34 during the balancing process, so the lifting occurs slightly sooner. Once the lifting is detected, the small counterweight 33 is set back to its initial position or the small lifting force is removed, allowing the perfect balance. This operation only uses a small amount of additional power.

In this implementation, the speed at which the mobile counterweight 32 is ‘falling’ along the lever 34 would have to be limited, for instance by viscous friction between the mobile counterweight 32 and the lever 34, in order to minimize the deceleration induced when the mobile counterweight 32 is stopped.

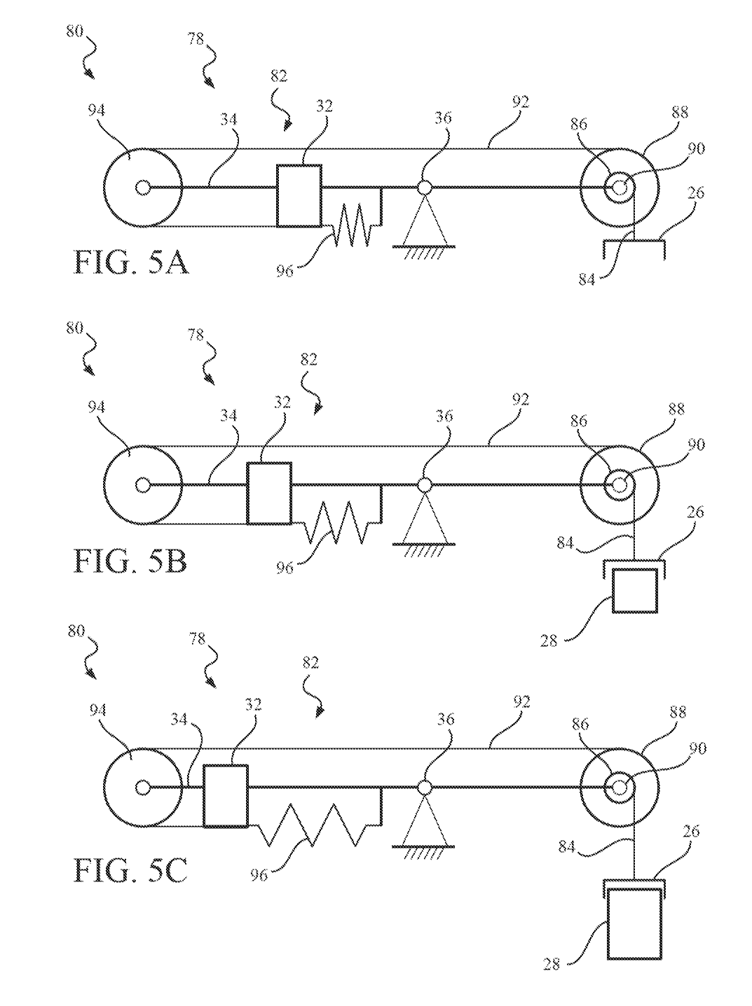

The balancing system is configured to adjust itself to the payload 28 without a controller and actuators under certain conditions. This is possible with the help of a mechanical scale system 80, including a spring scale 82. More specifically, referring to FIGS. 5A-5C, the mobile counterweight 32 is moved along the lever 34, away from the fixed pivot point 36 (i.e., the axis of rotation) along a lever 34 by a distance proportional to the weight of the payload 28, while the motion of the lever 34 is locked to a given position, as shown in FIGS. 5A and 5B. Once in equilibrium, the position of the mobile counterweight 32 is locked and the lever 34 is unlocked. In order to properly balance the system, a spring 96 with an appropriate stiffness is introduced. In other words, a spring scale 82 measures the weight of the payload 28. Instead of moving an indicator that would then move the mobile counterweight 32 accordingly, the spring scale 82 directly displaces the mobile counterweight 32. For better clarity, with continued reference to FIGS. 5B and 5C, the payload 28 is suspended on a first cable 84 that is attached to a third pulley 86. The third pulley 86 is rigidly connected to a fourth pulley 88—with a same center 90—to which a second cable 92 is attached. The second cable 92 winds around a fifth pulley 94 mounted to the opposing end of the lever 34 and is finally attached to the mobile counterweight 32. The mobile counterweight 32 is in turn attached to the end of a spring 96. The sequence of operations is similar to the gravity-powered balancing system presented above.

The system can work only under the following conditions. More specifically, the vertical height at which the payload 28 is grabbed by the end effector 26 must be higher than or equal to the height at which the payload 28 is released by the end effector 26. As discussed in the previous implementation, this vertical height difference is necessary because it is desired to avoid the use of a significant amount of energy to displace the mobile counterweight 32. The weighing of the payload 28 at the time of grasping the payload 28 must always be done at the same vertical height. This height for grasping the payload 28 is not necessarily to be the height where the lever 34 is horizontal. This is not a problem if the payloads 28 can always be grabbed at the same location. Meaning, if the weighing process is done at different vertical heights, the lever 34 will be at different angles during this weighing process and the spring 96 has to overcome the different amount of forces from the gravity of the mobile counterweight 32. In order to release the payload 28 at different vertical heights, the balancing conditions without payload 28 must be known in advance, which allows the position of the mechanical stop 77 to be set along the lever 34 accordingly. Otherwise, the mobile counterweight 32 would be at different positions, depending on the release angle, which would lead to incorrect no-load balancing. It should be pointed out that because the release of the payload 28 is vertically lower than the grasp, if no stopper position was determined from before, the mobile counterweight 32 would always be too close to the fixed pivot point 36 at release. However, since the mobile counterweight 32 is always stopped at a set position which is balanced for no payload 28, the no-load balancing is ensured. The payload 28 has to freely move vertically downwards in order to displace the mobile counterweight 32 and be mechanically weighed. The required displacement can be minimized if there is a sufficiently large transmission ratio between the motion of the payload 28 and the motion of the mobile counterweight 32 and the spring 96. The ratio of the radii of the two rigidly attached third and fourth pulleys 86, 88 on the payload 28 side of the lever 34 provides the transmission ratio. The spring 96 must be included in the mechanical scale system 80. The size and stiffness of the spring 96 can be minimized if there is a sufficiently large transmission ratio between the motion of the payload 28 and the motion of the mobile counterweight 32 and spring 96. Two locking systems 78 must be included, a first locking system for the fixed pivot point 36 and a second locking system for the mobile counterweight 32. The locking systems 78 allow the operator 30 to control the balancing state of the end effector 26. These locking systems 78 should not require significant power.

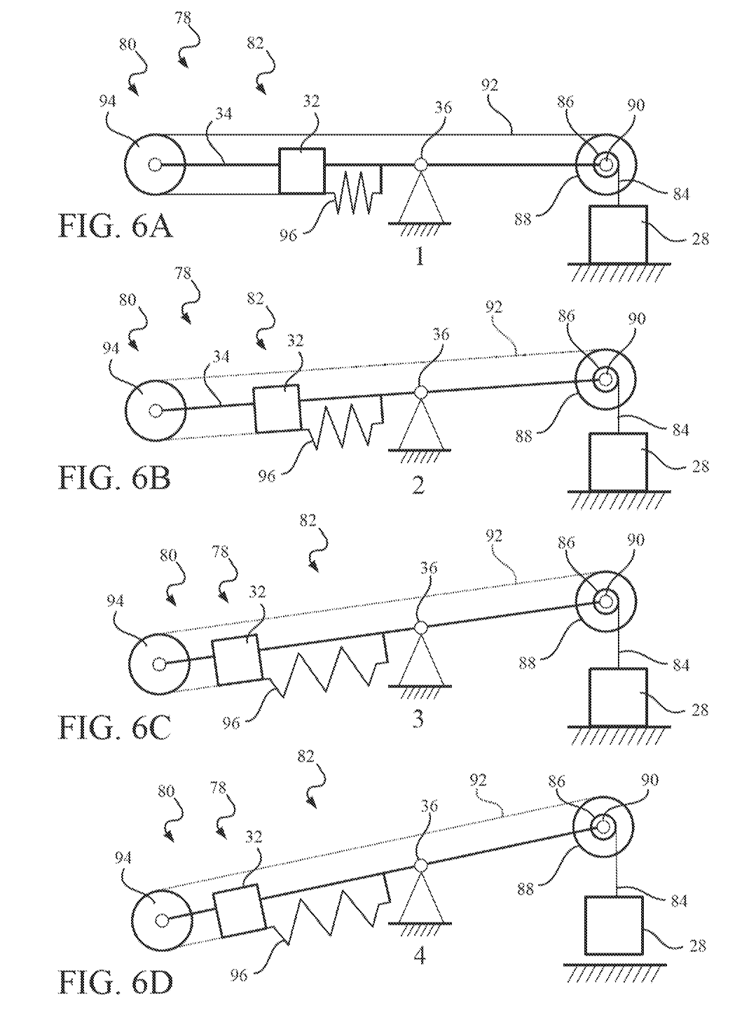

Referring now to FIG. 6A, the supported payload 28 is lifted with the mobile counterweight 32 and the fixed pivot point 36 is unlocked. It is noted that the lifting force required is minimal since the gravity powered system is statically balanced at all times. Since the payload 28 is supported, a slight raise of the lever 34 produces a pulling force on the cable. The mobile counterweight 32 then moves along the lever 34 accordingly, in order to maintain equilibrium, as shown in FIG. 6B. This motion continues in FIG. 6C until the payload 28 is raised, as shown in FIG. 6D, which leaves the mobile counterweight 32 in a balanced position. The mobile counterweight 32 is locked in the latter position as soon as a raising of the payload 28 is detected. The detection can be made by an automated system that monitors the motion of the payload 28 or detected by the operator 30.

When different payloads 28 are lifted away from the support, the lever 34 will be at different angles, depending on the weight of each payload 28. If the change of angle of the lever 34 during lifting of the payload 28 is small (with the use of a large transmission ratio) the change in payload 28 will lead to a linear change of the final angle after the weighing process. At the same time the spring force necessary to compensate gravity of the mobile counterweight 32 changes linearly. It is easy to compensate for this linear change of force by opting for a stiffer linear spring 96. Please note that this implementation could lead to a linear weighing angle with respect to the payload 28 mass, not a random weighing angle for a mass. The balanced payload 28 can then be handled by the operator 30 until the desired release location is reached.

Since the lever 34 moves during the weighing phase of the operation, the direction of the force applied by the mobile counterweight 32 on the spring 96 changes with respect to gravity, so does the magnitude of the applied force. It can be shown in the mathematical derivations below that this effect can be compensated for by a proper choice of the stiffness of the spring 96. With this scheme, there is no need to let the payload 28 drop. Also, there is no need for a locking system to be provided at the fixed pivot point 36.

It is noted that the lifting operation may be automated by making the system slightly unbalanced. This temporary imbalance can be obtained by the displacement of a small counterweight or by the application of a small lifting force on the lever 34 that could be activated by the operator 30 when the payload 28 is grasped and be deactivated when the lift of the payload 28 from its support is detected.

The system can work only under the following conditions. The height at which the payload 28 is grabbed must be higher than or equal to the height at which the payload 28 is released. As discussed in the previous implementation, this is necessary because it is desired to avoid the introduction of a significant amount of energy in the system. The weighing operation at grasping must always be done at the same height. The weighing height is not necessarily to be the height when the lever 34 is horizontal. This is not a problem if the payloads 28 can always be grabbed at the same location. In order to release the object at different heights, the balancing conditions without payload 28 must be known in advance, which allows the operator 30 to set the position of a mechanical stop accordingly. Otherwise, the mobile counterweight 32 would be at different positions depending on the release angle, which would lead to incorrect no-load balancing. It should be pointed out that because the release is lower than the grasp, if no stopper position was determined a priori, the mobile counterweight 32 would always be too close to the fixed pivot point 36 at release. However, since the mobile counterweight 32 is always stopped at a set position balanced for no load, the no-load balancing is ensured. The spring 96 must be included in the system. The size and stiffness of the spring 96 can be minimized if there is a sufficiently large transmission ratio between the motion of the payload 28 and the motion of the mobile counterweight 32 and spring 96 (given here by the ratio of the radii of the two rigidly connected pulleys on the payload 28 side). One locking system must be included for the mobile counterweight 32. It allows an operator 30 to control the balancing state of the assist device 16. This system should not require significant power.

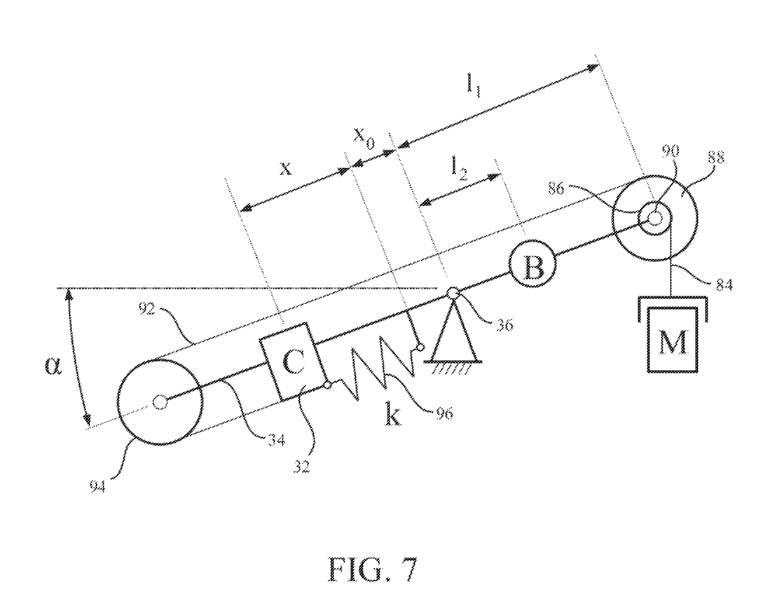

The mathematical relations that must be satisfied in order to obtain a correctly balanced system are presented here. The parameters are defined in FIG. 7. Angle a represents the orientation of the lever 34 with respect to a horizontal line. This angle takes the value α₁ when the weighing operation is initiated, and the value α₂ when the weighing operation is completed. In the case for which the payload 28 is dropped, angles α₁ and α₂ are identical (α₁=α₂). However, the two angles are different when the lifting action is used. The variables in the mechanical system represented in FIG. 7 are the mass M of the payload 28 and the spring 96 elongation x. The fixed mass B, the mobile mass C, the lengths I₁ and I₂ and the pulley ratio r are assumed to be known. Then, it can be shown that in order to correctly balance a system as illustrated in FIGS. 5A-5C (dropping of the payload 28) the stiffness of the spring 96 must be set to

$$k = \frac{Cg}{{l}_{1} r} . \qquad ( Equation 1 )$$

Also, it can be shown that in order to correctly balance the system illustrated in FIG. 6 (lifting of the payload 28), the stiffness of the spring 96 must be set to

$$k = \frac{2 Cg}{{l}_{1} r} . \qquad ( Equation 2 )$$

In both cases, the position of the spring 96 at zero force is given by

$${x}_{0} = \frac{{Bl}_{2}}{C} - \frac{Cg sin {α}_{1}}{k} . \qquad ( Equation 3 )$$

Also, the vertical displacement δ, between the lever 34 and the payload 28, needed to weigh the payload 28 M is given by

$$\frac{δ}{M} = \frac{{l}_{1}}{Cr} \qquad ( Equation 4 )$$

which corresponds to either a drop of the payload 28 as illustrated in FIGS. 5A-5C or to a vertical motion of the attachment point 62 of the lever 34 as illustrated in FIGS. 6A-6D.

It is noted that in the context of the implementation of FIGS. 3A-3J, the determination of the position of the mobile counterweight 32 that balances a loaded assist device 16 could be performed by weighing the payload 28 with a spring scale 82 similar to that of FIGS. 5A-5C. This can be done by positioning the mechanical stop using the weighing process similar to that of FIGS. 5A-5C. As the payload 28 drops the mechanical stop is dislocated along the lever 34 and the spring 96 is extended accordingly. Once the mechanical stop is at the weighed position where the spring force equals the gravity of the payload 28, it is locked. Please be noted that the pivot should be locked during this process as it will result in a significantly unbalanced structure. Only then, would the mobile counterweight 32 fall until it rests against the stopper which is located at the weighed position. Since the mobile counterweight 32 C does not move along the lever 34 during the weighing phase and since it can be assumed that the mechanical stop has a negligible mass, the weighing is independent from angle a. Therefore, the conditions of use would be a combination of those of the implementations of FIGS. 3 and 5. The resulting mathematical relations are identical to those presented in the previous section, except for the position of the spring 96 at zero force, which is given by the following equation:

$${x}_{0} = \frac{{Bl}_{2}}{C} . \qquad ( Equation 5 )$$

This system can work only under the following conditions. More specifically, the height at which the payload 28 is grabbed must be higher than a reference height and the height at which the payload 28 is released must be lower than the reference height. The lever 34 is horizontal in the reference height, allowing the mobile counterweight 32 to move in the appropriate direction for balancing. Also, under this condition, the energy needed to displace the mobile counterweight 32 is supplied by the gravitational potential energy lost by the payload 28 between its grasp and release states. The payload 28 has to freely move downwards in order to displace the stopper at the weighing position. The displacement required can be minimized if there is a sufficiently large transmission ratio between the motion of the payload 28 and the motion of the mechanical stop and spring 96. A spring 96 must be included in the system. The size and stiffness of the spring 96 can be minimized if there is a sufficiently large transmission ratio between the motion of the payload 28 and the motion of the scale stop and spring 96. Three locking systems 78 must be included: one for the pivot, one for the mobile counterweight 32 and one for the adjustable mechanical stop. These locking systems 78 allow an operator 30 to control the balancing state of the assist device 16. These systems should not require significant power.

Referring to FIG. 7, mathematical expressions can be obtained for the stiffness k of the spring 96 and the zero force position x₀ that lead to a balanced system for any given payload 28. The constant parameters for a given setup are the mobile counterweight 32 mass C, the lever 34 mass B, the position of the payload 28 l₁, the position of the center of mass of the lever 34 l₂, the transmission ratio r and the angle at the weighing position α₁. The mass of the payload 28 M, the extension of the spring x and the angle of the lever 34 at the end of the weighing operation, α₂, vary according to the payload 28 being handled. Therefore, k and x₀ must be independent from M, x, and α₂. It is recalled that α₁=α₂ if the payload 28 is dropped but α₁ ≠ α₂ if the payload 28 is lifted.

When the payload 28 is dropped, in order for the system to be balanced, the sum of the moments around the fixed pivot point 36 should be zero. That is,

Ml₁g cos α+Bl₂g cos α=C(x+x₀)g cos α (Equation 6)

which can be simplified to

Ml₁+Bl₂=C(x+x₀). (Equation 7)

At the end of the weighing operation, when the payload 28 is suspended in equilibrium, the sum of the forces along the cable should be zero. That is,

$$\frac{Mg}{r} + Cg sin {α}_{2} = kx . \qquad ( Equation 8 )$$

If there is no payload 28, then M=0 and α₁=α₂ in any case, since there is no drop or lift. In this situation, Equation 7 becomes:

$$\frac{{Bl}_{2}}{C} - {x}_{0} = {x}_{np} \qquad ( Equation 9 )$$

and Equation 8 becomes:

$$\frac{Cg sin {α}_{1}}{k} = {x}_{np} \qquad ( Equation 10 )$$

where xₙₚ is the extension of the spring 96 if there is no payload 28. Combining Equations 9 and 10, one obtains:

$${x}_{0} = \frac{{Bl}_{2}}{C} - \frac{Cg sin {α}_{1}}{k} . \qquad ( Equation 11 )$$

Then, substituting Equation 11 into Equation 7, one obtains:

$${Ml}_{1} + {Bl}_{2} = Cx + \frac{{CBl}_{2}}{C} - \frac{{C}^{2} g sin {α}_{1}}{k} \qquad ( Equation 12 )$$

which can be simplified and rearranged as:

$$\frac{{Ml}_{1}}{C} = x - \frac{Cg sin {α}_{1}}{k} . \qquad ( Equation 13 )$$

Also, Equation 8 can be rearranged as:

$$\frac{Mg}{kr} = x - \frac{Cg sin {α}_{2}}{k} . \qquad ( Equation 14 )$$

Then, combining Equations 13 and 14, and noting that α₁=α₂ since the payload 28 is being dropped, one obtains:

$$\frac{{Ml}_{1}}{C} = \frac{Mg}{kr} \qquad ( Equation 15 )$$

which can be simplified and rearranged as

$$k = \frac{Cg}{{l}_{1} r} . \qquad ( Equation 16 )$$

Then, the vertical displacement δ between payload 28 and the lever 34 during the weighing process is written as:

$$δ = \frac{x - {x}_{np}}{r} \qquad ( Equation 17 )$$

and replacing x from Equation 8 and xₙₚ from Equation 10 into the above equation, one obtains:

$$δ = \frac{Mg}{{kr}^{2}} . \qquad ( Equation 18 )$$

Then by replacing k from Equation 16, one obtains:

$$\frac{δ}{M} = \frac{{l}_{1}}{Cr} \qquad ( Equation 19 )$$

which completes the derivation of the equations that apply when the mobile counterweight 32 is involved in the weighing and the payload 28 is dropped.

The case that the payload 28 is weighed while being lifted is now considered. It is recalled that angle α₂ is the angle between the lever 34 and the horizontal direction at the end of the weighing operation, that is when the payload 28 begins to move, while α₁ is the angle at the beginning of the weighing phase. Equations 7 to 11 remain valid. However, since angles α₁ and α₂ are no longer equal, the rest of the derivation does not apply and new expressions must be sought. In addition to Equation 17, the following relation between the angles of the lever 34 and the vertical displacement at the payload 28 end of the lever 34 can be written as follows:

$$sin {α}_{2} - sin {α}_{1} = \frac{δ}{{l}_{1}} . \qquad ( Equation 20 )$$

Substituting Equation 11 into Equation 7, and rearranging, one obtains:

$$\frac{{Ml}_{1}}{C} = x - \frac{Cg sin {α}_{1}}{k} . \qquad ( Equation 21 )$$

Also, substituting Equation 10 into Equation 17, and rearranging, one obtains:

$$r δ = x - \frac{Cg sin {α}_{1}}{k} . \qquad ( Equation 22 )$$

Combining Equations 21 and 22, one obtains:

$$δ = \frac{{Ml}_{1}}{Cr} . \qquad ( Equation 23 )$$

Then, solving Equation 20 for sin α₂, substituting the result into Equation 8 and rearranging, one obtains:

$$\frac{Mg}{kr} + \frac{Cg δ}{{kl}_{1}} = x - \frac{Cg sin {α}_{1}}{k} . \qquad ( Equation 24 )$$

Then, combining Equations 21 and 24, one obtains:

$$\frac{{Ml}_{1}}{C} = \frac{Mg}{kr} + \frac{Cg δ}{{kl}_{1 }} . \qquad ( Equation 25 )$$

Substituting Equation 23 into Equation 25, one obtains:

$$\frac{{Ml}_{1}}{C} = \frac{Mg}{kr} + \frac{{CgMl}_{1}}{{kl}_{1} Cr} \qquad ( Equation 26 )$$

which can be simplified and rearranged as

$$k = \frac{2 Cg}{{l}_{1} r} \qquad ( Equation 27 )$$

which completes the derivation of the equations that apply when the mobile counterweight 32 is involved in the weighing and the payload 28 is lifted.

When the mobile counterweight 32 is not involved in the weighing phase, i.e., the mechanical stop directly displaced during the weighing phase, is now considered. In order for the system to be balanced, the sum of the moments around the fixed pivot point 36 should be zero, which results in Equation 7, as shown above. In the weighing configuration—with the mobile counterweight 32 disconnected from the spring 96 and second cable 92—the sum of the forces along the cable should be zero. That is,

$$\frac{Mg}{r} = kx . \qquad ( Equation 28 )$$

If there is no payload 28, then M=0 and Equation 7 becomes:

$$\frac{{Bl}_{2}}{C} - {x}_{0} = {x}_{np} \qquad ( Equation 29 )$$

while Equation 28 becomes:

0=xₙₚ. (Equation 30)

Combining Equations 29 and 30, one obtains:

$${x}_{0} = \frac{{Bl}_{2}}{C} . \qquad ( Equation 31 )$$

Then, by replacing x₀ in Equation 7, one obtains:

$${Ml}_{1} + {Bl}_{2} = Cx + \frac{{CBl}_{2}}{C} \qquad ( Equation 32 )$$

which can be simplified and rearranged as:

$$\frac{{Ml}_{1}}{C} = x . \qquad ( Equation 33 )$$

Also, Equation 28 can be rearranged as:

$$\frac{Mg}{kr} = x . \qquad ( Equation 34 )$$

Then, combining Equations 33 and 34, one obtains:

$$k = \frac{Cg}{{l}_{1} r} \qquad ( Equation 35 )$$

which is identical to Equation 16. Finally, δ is obtained by replacing Equations 28 and 30 in Equation 17, which results in Equation 18 and completes the derivation of the equations for the case for which the mobile counterweight 32 is not involved in the weighing phase.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A balance assist system comprising:
a support structure;
an assist device movably supported by the support structure, the assist device configured for movement relative to the support structure along at least one of an X axis and a Y axis;
a mass vertically supported by the assist device;
a variable balancing system configured for moving the mass in a vertical direction along a Z axis, the variable balancing system including:
a balance platform;
a lever pivotally attached to the balance platform at a fixed pivot point such that the lever is pivotable at the fixed pivot point about a balance axis;
a mobile counterweight movably disposed on the lever relative to the fixed balance axis between a minimum position and a maximum position; and
a balancing cable operatively connecting the support structure, the lever, and the mass such that the mass is vertically supported by the support structure via the balancing cable;
wherein the minimum position corresponds to the mass having a minimum weight such that the mass is statically balanced along the Z axis; and
wherein the maximum position corresponds to the mass having a maximum weight such that the mass is statically balanced along the Z axis.

2. A balance assist system, as set forth in claim 1, wherein the mobile counterweight is closer to the balance axis in the minimum position than when the mobile counterweight is in the maximum position.

3. A balance assist system, as set forth in claim 2, further comprising a first pulley operatively attached to the support structure;
wherein the balancing cable extends about the first pulley and the balancing cable operatively connects the mass and the lever such that movement of the mass along the Z axis is decoupled from movement of the mass along each of the X axis and the Y axis; and
wherein vertical movement of the mass along the Z axis causes the lever to pivot about the balance axis.

4. A balance assist system, as set forth in claim 3, further comprising a second pulley operatively disposed between the first pulley and the lever;
wherein the balancing cable is further defined as extending about the first pulley and the second pulley; and
wherein the second pulley is operatively connected to an end of the lever such that pivoting of the lever about the balance axis causes the second pulley to move in unison with movement of the end of the lever.

5. A balance assist system, as set forth in claim 3, wherein the mobile counterweight is configured to move along the lever between the minimum position and the maximum position in response to the lever pivoting about the fixed pivot point.

6. A balance assist system, as set forth in claim 4, wherein the mobile counterweight is further defined as being configured to move along the lever in response to gravity.

7. A balance assist system, as set forth in claim 5, wherein the variable balancing system further includes a brake disposed at the fixed pivot point;
wherein the brake is configured to be selectively activated to prevent pivoting of the lever about the balance axis at the fixed pivot point.

8. A balance assist system, as set forth in claim 6, wherein the mobile counterweight is configured to be selectively locked with respect to the lever such that the mobile counterweight is prevented from moving along the lever.

9. A balance assist system, as set forth in claim 1, wherein the mass includes an end effector configured for selectively supporting a payload in the vertical direction.

10. A balance assist system, as set forth in claim 8, wherein the assist device includes:
a bridge crane movably attached to the rails and configured for movement relative to the rails along the Y axis;
a trolley movably attached to the bridge crane and configured for movement relative to the bridge crane along the X axis;
wherein the end effector operatively extends from the trolley.

11. A variable balancing system configured for moving a mass in a vertical direction along a Z axis, the variable balancing system comprising:
a balance platform;
a lever pivotally attached to the balance platform at a fixed pivot point such that the lever is pivotable at the fixed pivot point about a balance axis;
wherein the lever is configured to be operatively attached to a balancing cable such that the balancing cable vertically supports the mass; and
a mobile counterweight movably disposed on the lever relative to the balance axis between a minimum position and a maximum position;
wherein the minimum position corresponds to the mass having a minimum weight such that the mass is statically balanced along the Z axis; and
wherein the maximum position corresponds to the mass having a maximum weight such that the mass is statically balanced along the Z axis.

12. A balance assist system, as set forth in claim 10, wherein the mobile counterweight is closer to the balance axis in the minimum position than when the mobile counterweight is in the maximum position.

13. A balance assist system, as set forth in claim 12, wherein the mobile counterweight is configured to move along the lever between the minimum position and the maximum position in response to the lever pivoting about the fixed pivot point.

14. A balance assist system, as set forth in claim 13, wherein the mobile counterweight is configured to move along the lever in response to gravity.

15. A balance assist system, as set forth in claim 14, wherein the variable balancing system further includes a brake disposed at the fixed pivot point;
wherein the brake is configured to be selectively activated to prevent pivoting of the lever about the fixed pivot point.

16. A balance assist system, as set forth in claim 15, wherein the mobile counterweight is configured to be selectively locked with respect to the lever such that the mobile counterweight does not move along the lever.

17. A method of balancing a variable balancing system having a lever pivotally supported at a pivot point, the method comprising:
vertically supporting a mass along the Z axis by a lever;
moving a counterweight along the lever to change a center of gravity of the lever; and
stopping movement of the counterweight along the lever once the center of gravity of the lever is coincident with the mass such that the mass is statically balanced along the Z axis.

18. A method, as set forth in claim 17, further comprising moving the mass along the Z axis to cause the lever to pivot about a balance axis at the pivot point; and
wherein the counterweight moves along the pivoted lever in response to gravity.

19. A method, as set forth in claim 18, wherein moving a counterweight along the lever is further defined as:
moving a first counterweight along the lever such that the first counterweight applies a force on the lever until the lever is in a balanced position; and
moving a second counterweight along the lever; and
wherein stopping movement is further defined as stopping movement of the second counterweight along the lever once the center of gravity of the lever is coincident with the mass such that the mass is statically balanced along the Z axis.

20. A method, as set forth in claim 17, further comprising:
locking the pivot point to prevent pivoting of the lever;
locking the counterweight to prevent movement along the lever once the counterweight has moved a distance along the lever which is proportional to a weight of the mass; and
unlocking the pivot point once the counterweight is locked to the lever.
